(19) United States
(12) Patent Application Publication
(10) Pub. No.: US 2013/0081038 A1
(43) Pub. Date: Mar. 28, 2013

(54) MULTIPROCESSOR COMPUTING DEVICE

(71) Applicant: International Business Machines Corporation, Armonk, NY (US)

(72) Inventors: Eli M. Dowf, Poughkeepsie, NY (US); Marie R. Laser, Poughkeepsie, NY (US); Jessie Yu, Wappinger Falls, NY (US)

(73) Assignee: INTERNATIONAL BUSINESS MACHINES CORPORATION, Armonk, NY (US)

(21) Appl. No.: 13/680,369

(22) Filed: Nov. 19, 2012

Related U.S. Application Data
(63) Continuation of application No. 12/410,893, filed on Apr. 14, 2009.

(51) Int. Cl. G06F 9/46

(52) U.S. Cl. 718/102

(57) ABSTRACT

A computing device includes a first processor configured to operate at a first speed and consume a first amount power and a second processor configured to operate at a second speed and consume a second amount of power. The first speed is greater than the second speed and the first amount of power is greater than the second amount of power. The computing device also includes a scheduler configured to assign processes to the first processor only if the processes utilize their entire timeslice.

### CROSS-REFERENCE TO RELATED APPLICATIONS AND PRIORITY CLAIM

This application is a continuation of U.S. non-provisional application Ser. No. 12/410,893, entitled “MULTIPROCESSOR COMPUTING DEVICE”, filed Apr. 14, 2009, which is incorporated herein by reference in its entirety.

### BACKGROUND

The present invention relates to computing devices, and more specifically, to reducing power consumption during operation of computing devices.

To reduce power consumption, modern processors in computing devices are generally designed to go into deep C-state sleep while idling and wake up when an interrupt takes place. For example, the “C3-state” (often known as “Sleep”) is a state where the processor does not need to keep its cache coherent, but maintains other state information. Some processors have variations on the C3 state (Deep Sleep, Deeper Sleep, etc.) that differ in how long it takes to wake the processor. However, a process that would normally demonstrate spinlock acquisition behaviors could negatively impact this power saving mechanism due to the decrease in sleep state residency, or prevention of entering sleep states, as well as increasing the energy cost associated with state transitions.

Spinlock processes are an example of a process that prevents a processor from going into deep C-state sleep. A spinlock is a lock where the requesting thread simply waits in a loop (“spins”) repeatedly checking until the lock becomes available. As the thread remains active but isn't performing a useful task, the use of such a lock is a kind of “busy waiting.” Once acquired, spinlocks will usually be held until they are explicitly released, although in some implementations they may be automatically released if the thread blocks, or “goes to sleep”. Spinlocks are efficient if threads are only likely to be blocked for a short period of time, as they avoid overhead from operating system process re-scheduling or context switching. For this reason, spinlocks are often used inside operating system kernels. However, spinlocks become wasteful if held for longer durations as they may prevent other threads from running and require re-scheduling. The longer a lock is held by a thread, the greater the risk it will be interrupted by the 0/S scheduler while holding the lock. If this happens, other threads will be left “spinning” (repeatedly trying to acquire the lock), while the thread holding the lock is not making progress towards releasing it. The result is a semi-deadlock until the thread holding the lock can finish and release it. This is especially true on a single-processor system, where each waiting thread of the same priority is likely to waste its quantum (allocated time where a thread can run—also referred to as a timeslice herein) spinning until the thread that holds the lock is finally finished.

### SUMMARY

According to one embodiment of the present invention, a computing device including a first processor configured to operate at a first speed and consume a first amount power and a second processor configured to operate at a second speed and consume a second amount of power, wherein the first speed is greater than the second speed and the first amount of power is greater than the second amount of power is provided. The computing device of this embodiment also includes a scheduler configured to assign processes to the first processor only if the processes utilizes their entire timeslice.

Another embodiment of the present invention is directed to a method of assigning processes to a first processor or a second processor in a multiprocessor computing device. The method of this embodiment includes ascertaining that the first processor operates faster and consumes more power than the second processor; determining whether a process is now or continues to operate as a spinlock process, a process with a sleeper bonus, or another type of process; and assigning the process to the second processor in the event that the process is a spinlock process or a process with a sleeper bonus, otherwise, assigning the process to the first processor.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 shows an example of a computing device on which embodiments of the present invention may be implemented;

FIG. 2 shows a computing device including two processors according to one embodiment of the present invention; and

FIG. 3 shows a method of assigning processes to particular processors according one embodiment of the present invention.

### DETAILED DESCRIPTION

Embodiments of the present invention may achieve reduced power reduction by implementing a slower, low-voltage dedicated processor with the main processor(s) for sleeper and/or spinlock processes. It should be apparent to those skilled in the art that in this context the term processor may also be used to mean a particular core of a multicore processor architecture that implements asymmetric function or power consumption characteristics with respect to those cores. The main processor(s) may be reserved for only processes that are CPU bound and use their entire timeslices. This way the main processor(s) would be more likely to remain in one state and therefore maximizing the full benefits of the power saving of allowing the main processor(s) to go into a deep-C sleep state. To this end, it should be understood that the secondary processor may, in one embodiment, operate at a lower voltage than the main processor(s). As a result, the secondary processor may operate at a slower speed.

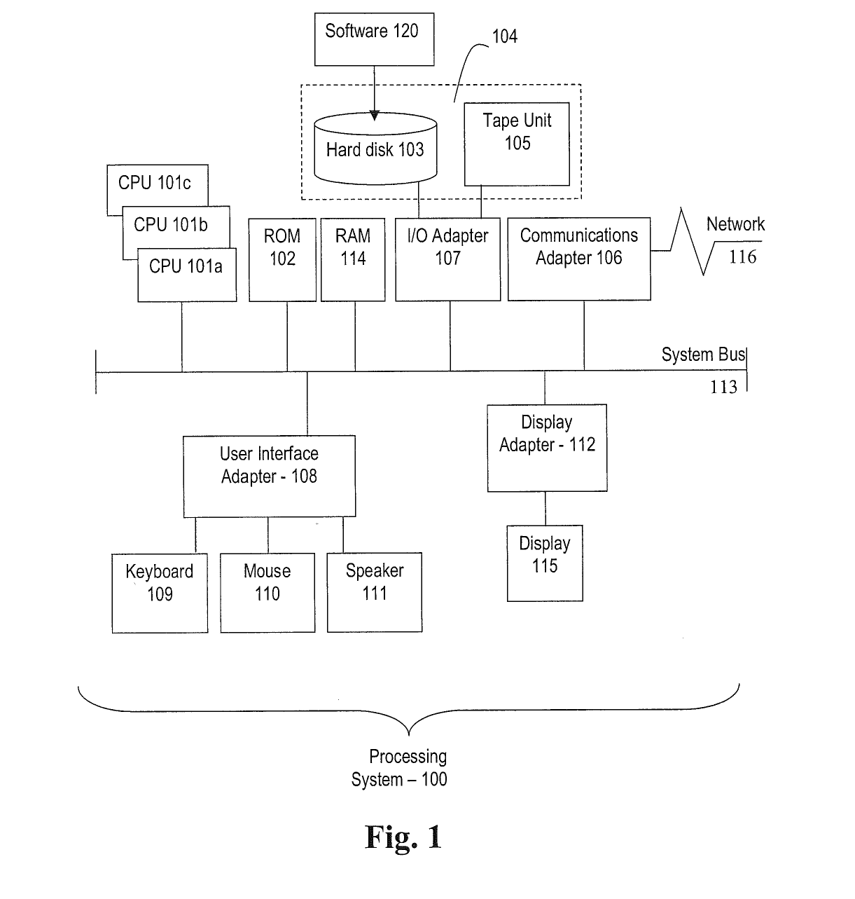

Referring to FIG. 1, there is shown an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 1 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Components Interface (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

Thus, as configured in FIG. 1, the system 100 includes processing means in the form of processors 101, storage means including system memory 114 and mass storage 104, input means such as keyboard 109 and mouse 110, and output means including speaker 111 and display 115. In one embodiment, a portion of system memory 114 and mass storage 104 collectively store an operating system such as the AIX® operating system from IBM Corporation to coordinate the functions of the various components shown in FIG. 1.

It will be appreciated that the system 100 can be any suitable computer or computing platform, and may include a terminal, wireless device, information appliance, device, workstation, mini-computer, mainframe computer, personal digital assistant (PDA) or other computing device. It shall be understood that the system 100 may include multiple computing devices linked together by a communication network. For example, there may exist a client-server relationship between two systems and processing may be split between the two.

Examples of operating systems that may be supported by the system 100 include Windows 95, Windows 98, Windows NT 4.0, Windows XP, Windows 2000, Windows CE, Windows Vista, Mac OS, Java, AIX, LINUX, and UNIX, or any other suitable operating system. The system 100 also includes a network interface 106 for communicating over a network 116. The network 116 can be a local-area network (LAN), a metro-area network (MAN), or wide-area network (WAN), such as the Internet or World Wide Web.

Users of the system 100 can connect to the network through any suitable network interface 116 connection, such as standard telephone lines, digital subscriber line, LAN or WAN links (e.g., T1, T3), broadband connections (Frame Relay, ATM), and wireless connections (e.g., 802.11(a), 802.11(b), 802.11(g)).

As disclosed herein, the system 100 includes machine-readable instructions stored on machine readable media (for example, the hard disk 104) for capture and interactive display of information shown on the screen 115 of a user. As discussed herein, the instructions are referred to as “software” 120. The software 120 may be produced using software development tools as are known in the art. The software 120 may include various tools and features for providing user interaction capabilities as are known in the art.

In some embodiments, the software 120 is provided as an overlay to another program. For example, the software 120 may be provided as an “add-in” to an application (or operating system). Note that the term “add-in” generally refers to supplemental program code as is known in the art. In such embodiments, the software 120 may replace structures or objects of the application or operating system with which it cooperates.

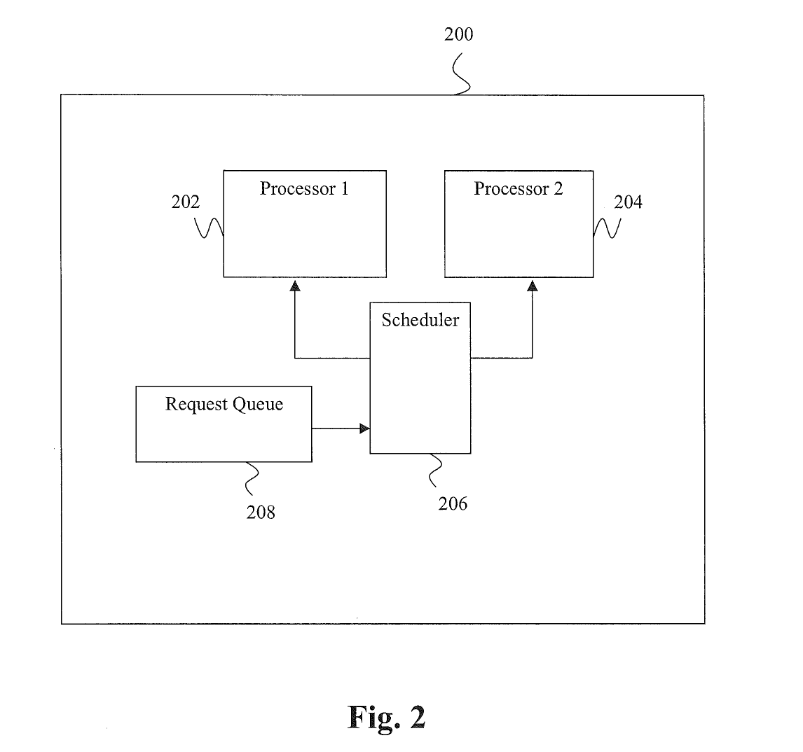

FIG. 2 shows a more specific example of a computing device 200. The computing device 200 may be any type of computing device that may include two or more processors. As shown, the computing device 200 includes a first processor 202 and a second processor 204. In one embodiment, the first processor 202 is the main processor. To this end, in one embodiment, it may be preferable to run processes that utilize most or all of their timeslices on the first processor 202. This may help keep the first processor 202 running at full capacity when actively processing a particular process. In one embodiment, the first processor 202 operates at a higher voltage than the second processor 202.

The second processor 204 may be a processor consumes less power than the first processor 202. In one embodiment, this lower power second processor 204 may also run at a slower speed than the first processor 204.

The computing device 200 may also include a scheduler 206. The scheduler 206 is configured to assign processes from the request queue 208 to either the first processor 202 or the second processor 204.

According to one embodiment, the scheduler 206 may be configured to assign processes that utilize less power than other processes to the second processor 204. Spin lock processes or so called sleeper processes may, in one embodiment, always or almost always be assigned to the second processor 206. This is due, at least in part, to the fact that both of these types of processes do not fully utilize either the processing capability of a high speed processor or the full time slice allotted to them. For example, a sleeper process may only utilize a portion of its time slice, surrendering its remaining allocated time slice in trade for a future sleeper bonus as is referred to in the art. As these processes do not fully utilize the first processor 202, they may be assigned to the second processor 204. It will be understood that a programmer may indicate in code whether a particular process should be assigned to the slower processor. Another way in which the scheduler 206 may assign processes is based on historical records of whether a particular process frequently spun while acting on a spinlock or included a sleeper bonus. If so, the scheduler may assign such processes to the second processor 204.

In one embodiment, the second processor 204 may include a subset of the general purpose instructions stored on other, faster processors in the system (for example, the first processor 202). In one embodiment, this subset may include general purpose instructions such as atomic test and set instructions or additional instructions not kept on the primary processor. In addition, the second processor 204 may include registers for storing data.

In one embodiment, the first 202 and second processors 204 may include programs or hardware configured to determine the power usage of the processor. This data may be stored, for example, in the processors (202 and 204) or otherwise made available to the scheduler 206 and or any userspace processes as needed.

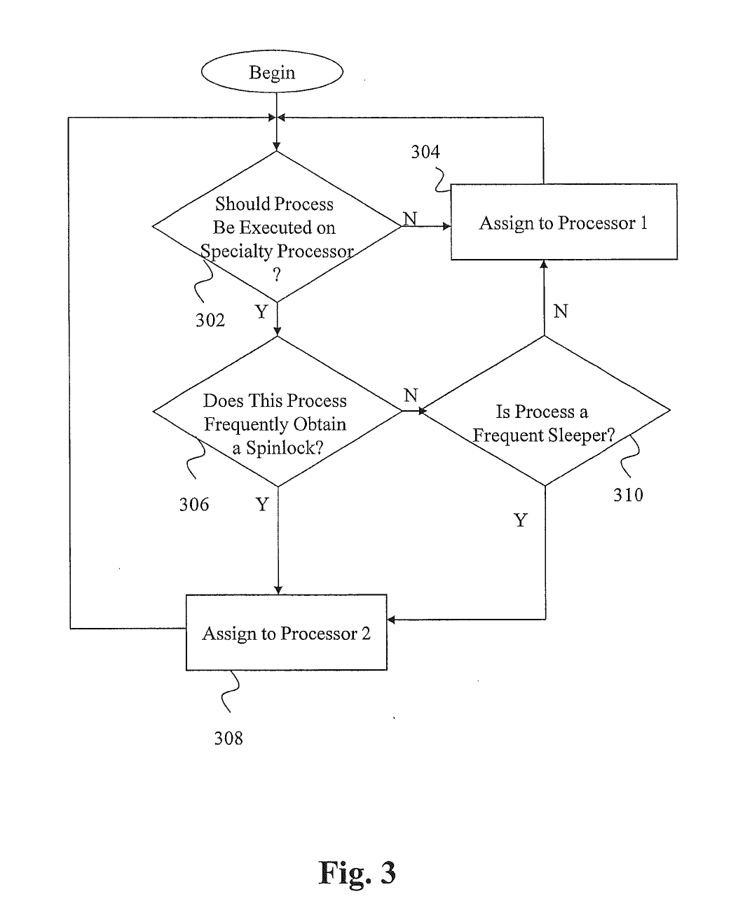

FIG. 3 is a flow chart showing a method by which the scheduler 206 (FIG. 2) may determine which of the processors (faster or slower) to assign a particular process. The process begins at a block 302 where the next process in the request queue is examined to determine if it is a process which might be more optimally executed on a specialty processor. This determination may involve examining a table or other type of record that contains an indication of whether the process is a high or low power consumer (as inferred from the utilization of processor time to accomplish program instruction execution which is not bus waiting as known in the art). The contents of the table or other record may include an indication created at compile time for the process if such was indicated and is supported by the scheduler. That is, the programmer could force the process to one or the other processor at design time by indicating the choice in the software. This may be done, for example, by including special instructions in the software capable of informing a compiler that a section or region or code is optimally executed on either the first or second processor. Of course, the table could be created and populated by the scheduler itself based on historical data. For example, if a process is regularly providing a sleeper bonus or behaving as a spin lock process, that process could be tagged as being assigned to the slower processor.

In the event that the process is not a process to be executed on a specialty processor (i.e., the coding or history indicate it should run on the fastest processor) at a block 304 it is assigned to processor 1. That is, in the event the process has been determined not to frequently obtain spinlocks, has not been identified as a frequent sleeper, or other candidate process which is more optimally executed on a low power processor with respect to power savings it is assigned to the faster first processor at a block 304. Operation in the first processor is then carried out in the normal manner. That is, assignment of the process does not, in one embodiment, affect how the process is operated on by the processor to which it is assigned. Otherwise, processing progresses to a block 306.

In the event that the process is not to already marked as to be executed on a special processor, at a block 306 it is determined whether the process frequently obtains a spinlock. This determination may be made in several ways. For example, the compiler may be able to determine that the process requests as asset and then does not release the asset until a certain response is received by examining the language constructs or API used by the programmer. Alternatively, the scheduler could determine, based on historical data, that the process ties up a particular assert for extended time periods while not performing any other processing. Furthermore, during execution of the process it may be determined that the process is spinning/waiting for a spinlock that is not immediately available, that process may “become” a spinlock process. To that end, block 306 may continually monitor each executing process to determine if the process has become a special process. In such a case, an previously started process may be moved from the first processor to the second processor or vice versa. Of course, one of ordinary skill will realize that care must be taken to avoid bouncing a single process between the processor multiple times as it changes state.

Regardless, if the process is a spin lock process, it is assigned to the second processor at a block 308. In the event that the process is not a spin lock process, at a block 310 it is determined whether the process has a sleeper bonus. This may be determined, as described above, by either programmer indication, historical review or by monitoring the execution of the process in real time. Regardless, if the process has an associated sleeper bonus it is assigned to the second processor at block 308. Otherwise, the process is assigned to the first processor at block 304. It should be understood that the scheduler may require a consistent sleeper bonus from a particular process before it may determine that it should be assigned to the second processor. Furthermore, once assigned, the process may always be so assigned until it displays a history of not providing a sleeper bonus.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one ore more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A method of assigning processes to a first processor or a second processor in a multiprocessor computing device, the method comprising:
ascertaining that the first processor operates faster and consumes more power than the second processor;
determining whether a process is now or continues to operate as a spinlock process, a process with a sleeper bonus, or another type of process; and
assigning the process to the second processor in the event that the process is a spinlock process or a process with a sleeper bonus, otherwise, assigning the process to the first processor.

2. The method of claim 1, wherein determining includes monitoring the process each time it runs and storing the power consumption during the time that it runs.

3. The method of claim 1, wherein determining includes receiving an input from a compiler program.

4. The method of claim 1, wherein the first processor includes a general instruction set and the second processor includes a subset of the general instruction set.

5. The method of claim 1, wherein the second processor includes registers and atomic test and set instructions.
